(19) United States
(12) Patent Application Publication
(10) Pub. No.: US 2025/0352432 A1
(43) Pub. Date: Nov. 20, 2025

(54) MEDICATION DELIVERY UNIT SYSTEM AND METHOD OF USE

(71) Applicant: Medication Management Services, Inc, Ebensburg, PA (US)

(72) Inventors: Christopher E. Bossi, Altoona, PA (US); Simon J. Passmore, Shrewsbury, MA (US)

(73) Assignee: Medication Management Services, Inc, Ebensburg, PA (US)

(21) Appl. No.: 19/203,492

(22) Filed: May 9, 2025

Related U.S. Application Data
(60) Provisional application No. 63/648,705, filed on May 17, 2024.

(51) Int. Cl. A61J 7/00; A61J 1/14

(52) U.S. Cl. CPC A61J 7/0076; A61J 1/14

(57) ABSTRACT

A medication delivery unit is provided for managing, storing, and delivering medication to a patient. The unit includes a rack for storing a plurality of cartridges for storing medication. Each cartridge may have drawers which are further subdivided into pill slots where individual pills or doses may be stored. A pill retrieval system positions a collection head via a gantry system for pill retrieval. The collection head draws the selected cartridge and drawer from the storage rack allowing a pill to fall into a pill receptacle. After collecting the pill(s), the gantry moves the collection head and pill receptacle to an access port where the pill(s) can be picked up by the patient. Methods are providing for loading and operating the MDU as part of a system.

### RELATED APPLICATION

This application claims priority under 35 U.S.C. § 119 (e) to U.S. provisional patent application, U.S. Ser. No. 63/648,705, filed May 17, 2024, which is herein incorporated by reference in its entirety.

### BACKGROUND

The various aspects described herein relate to patient medication management.

In U.S. Pat. No. 7,451,876, issued Nov. 18, 2008, Christopher E. Bossi et al. describe a medication carrier for administering individual doses of therapeutic products to a patient, in a non-sequential fashion. The medication carrier has a receptacle which stores individually sealed, unit dose packages in random order, allowing each unit dose package to be easily accessed and released in response to automated or manual extraction. The medication carrier includes an array of stalls and secures the sealed unit dose packages within the stalls until a scheduled dosing time. The unit dose packages are oriented such that identifiers imprinted thereon can be easily read without removing the packages from the carrier.

In U.S. Pat. No. 7,828,147, issued Nov. 9, 2011, Cathy L. Caracciolo et al. describe a multi-layer medication carrier. The carrier has a support layer with openings to receive corresponding blisters formed in a blister layer. A backing layer is provided over the blister layer to form enclosures for holding unit doses of a medication. Perforations provided in at least the blister layer define unit dose packages. Dimples may be provided in the blister layer within a boundary defined by the perforations to ensure subsequent ejection of each unit dose package. An adhesive-free region in the backing layer is provided in alignment with the perforations defining each unit dose package to further ensure proper ejection. Additionally, a partial-depth cut in the backing layer is provided in substantial alignment with each blister, thereby facilitating removal of the unit dose of medication.

In U.S. Pat. No. 8,019,471, issued Sep. 13, 2011, Robert C. B ogash et al. describe an integrated medication management and compliance system for enabling a care provider to remotely manage and deliver individual doses of therapeutic products to a patient, in a non-sequential fashion. The system includes a delivery apparatus remotely located from the care provider. The delivery apparatus stores a sealed unit dose packages that are delivered to a patient at a scheduled dosing time. The delivery apparatus is coupled to a control facility and to a computer terminal of the care provider by way of a secure communications network. The system enables the patient's medication regimen to be remotely tailored in real-time to accommodate fluid medical conditions. In U.S. Pat. No. 8,600,548, issued Dec. 13, 2013, which is a continuation-in-part of the same family as the U.S. Pat. No. 8,019,471 patent, Christopher E. Bossi et al. disclose additional embodiments of the integrated system.

In US Patent Publication No. US2021/0002015, published Jan. 7, 2021, K utagdgu A kdogan et al. describe a dispensable retrieval mechanism programmed to carry out blind retrievals of pills using a retrieval strategy with a predetermined sequence of retrieval attempts.

In U.S. Pat. No. 9,501,887, issued Nov. 22, 2016, Michel J. Berg et al. describe an automated storage and retrieval systems for medications. The system has a singulator to confirm or identify the objects being dispensed. A variable orifice is dynamically adjustable to a specific object or pill size. Retrieving medications is accomplished by advancing/retracting a flexible tube.

The subject matter discussed in the background section should not be considered prior art merely because of its mention in the background section. Similarly, a problem mentioned in the background section or associated with the subject matter of the background section should not be considered to have been previously recognized in the prior art. The subject matter in the background section merely represents different approaches, which in and of themselves, may also correspond to claimed embodiments.

### SUMMARY

A medication delivery unit is provided for managing, storing, and delivering medication to a patient. The unit includes a rack for storing a plurality of cartridges for storing medication. Each cartridge may have drawers which are further subdivided into pill slots where individual pills or doses may be stored. A pill retrieval system positions a collection head via a gantry system for pill retrieval. The collection head draws the selected cartridge and drawer from the storage rack allowing a pill to fall into a pill receptacle. After collecting the pill(s), the gantry moves the collection head and pill receptacle to an access port where the pill(s) can be picked up by the patient. Methods are providing for loading and operating the MDU as part of a system.

On aspect relates to a system comprising a plurality of cartridges, each cartridge having a drawer with a plurality of partitions and a linear gear for drawing the drawer from said cartridge; a cartridge rack having a plurality of slots for holding the plurality of cartridges; a collection head having a collection receptacle and a pinion for engaging the linear gears; a gantry system, operably connected to the collection head, to move the collection head within a range of motion of at least two dimensions; and a motor operably connected to drive the pinion.

In some embodiments, the system further comprises a processor; and a non-transitory computer-readable storage medium having stored thereon at least one software module having code executable by the processor, the at least one software module including a gantry control module to position the collection head with the pinion engaged to the linear gear of a selected drawer among the plurality of cartridges, wherein, if the pinion is engaged with the linear gear of the selected drawer, the collection receptacle is directly below where the selected drawer opens.

In some embodiments of the system, the at least one software module further includes a motor control module to control the motor to drive the pinion engaged to the linear gear and draw the selected drawer to a selected partition among the plurality of partitions.

In some embodiments, the system further comprises a plurality of cartridge locks for securing the plurality of cartridges within the cartridge rack, wherein, the at least one software module further includes a cartridge lock control module to control the plurality of cartridge locks.

In some embodiments, the system further comprises a housing with a patient access port, wherein the plurality of cartridges, the cartridge rack, the collection head, the gantry system and the motor are enclosed within the housing; and the gantry system has a first position in the range of motion to at least in part position the collection receptacle at the patient access port.

In some embodiments of the system, the collection receptacle is on a linear track on the collection head and the linear track has (i) a second position wherein the collection receptacle, in combination with positioning the collection head at the first position via the gantry system, is at the patient access port, and (ii) a third position for placing the collection receptacle for collecting contents from the plurality of cartridges.

In some embodiments of the system, the pinion is a first pinion; the linear gear is a first linear gear; each cartridge further comprises a second linear gear for drawing said cartridge from the cartridge rack; the collection head further comprises a second pinion for engaging the second linear gears; and the first pinion is setback from the second pinion on the collection head in a direction the plurality of cartridges are drawn from the cartridge rack.

In some embodiments of the system, the collection head has a first support structure and a second support structure; the first pinion is mechanically held at a distal end of the first support structure; the second pinion is mechanically held at a distal end of the second support structure; and the first and second support structures are rigidly connected to one another.

Another aspect relates to a method comprising acts of (i) providing a plurality of cartridges, each cartridge having a drawer with a plurality of partitions and a linear gear for drawing the drawer from said cartridge; (ii) storing a plurality of objects in the plurality of partitions of the drawers of the plurality of cartridges; (iii) storing the plurality of cartridges in a plurality of slots of a cartridge rack; (iv) providing a collection head having a collection receptacle and a pinion for engaging the linear gears; (v) providing a gantry system operably connected to the collection head, the gantry system for moving the collection head within a range of motion of at least two dimensions; (vi) controlling the gantry system to at least in part position the pinion of the collection head in the linear gear of the drawer of a selected cartridge among the plurality of cartridges; (vii) turning the pinion to draw the drawer from the selected cartridge to a selected partition, the selected partition storing at least one selected object among the plurality of objects; (viii) receiving the at least one selected object in the collection receptacle; and (ix) controlling the gantry system and the collection head to position the collection receptacle at an access port.

In some embodiments of the method, the pinion is a first pinion; the linear gear is a first linear gear; each cartridge further comprises a second linear gear for drawing said cartridge from the cartridge rack; the collection head further comprises a second pinion for engaging the second linear gears; and act (vi) comprises (a) controlling the gantry system to position the second pinion of the collection head in the second linear gear of the selected cartridge, and (b) turning the second pinion, to draw the selected cartridge from its slot of the cartridge rack, at least until the first pinion is positioned in the first linear gear.

In some embodiments, the method further comprises unlocking a cartridge lock securing the selected cartridge within the slot of the cartridge rack.

In some embodiments of the method, in act (vii), turning the first pinion, causes the second pinion to disengage the second linear gear.

In some embodiments of the method, in act (vii) the pinion is turned in a first direction, and the method further comprises after act (viii), turning the first pinion in an second direction opposite the first direction, at least until the drawer is retuned into the selected cartridge and the second pinion is again positioned in the second linear gear.

Yet another aspect relates to a method comprising acts of (i) providing a plurality of cartridges, each cartridge having a drawer with a plurality of partitions; (ii) storing an object in a select partition among the plurality of partitions in the drawer of a selected cartridge among the plurality of cartridges; (iii) storing the plurality of cartridges in a plurality of slots of a cartridge rack; (iv) first controlling a gantry system to position a collection head at the drawer of the selected cartridge; (v) drawing the drawer from the selected cartridge to the selected partition; (vi) receiving the object in a collection receptacle of the collection head; (vii) retuning the drawer into the selected cartridge; and (viii) second controlling the gantry system and the collection head to position the collection receptacle at an access port.

In some embodiments of the method, the object is a pill.

In some embodiments of the method, the drawer of each cartridge has a linear gear for drawing said drawer from said cartridge; the collection head has a pinion for engaging the linear gear; the act of first controlling comprises positioning the pinion in the linear gear of the drawer of the selected cartridge; and the act of drawing the drawer comprises turning the pinion in the linear gear.

In some embodiments of the method, each cartridge has a first linear gear for drawing said cartridge from its respective slot of the cartridge rack; the drawer of each cartridge has a second linear gear for drawing said drawer from said cartridge; the collection head has a first pinion for engaging the first linear gear and a second pinion for engaging the second linear gear; the act of first controlling comprises positioning the first pinion in the first linear gear of the selected cartridge; the act of drawing comprises turning the first pinion in the first linear gear in a first direction to draw the selected cartridge from its respective slot in the cartridge rack until the second pinion engages the second linear gear; and turning the second pinion in the second linear gear in the first direction to draw the drawer of the selected cartridge to the selected partition; and the act of returning comprises turning the second pinion in the second linear gear in a second direction to return the drawer into the selected cartridge, wherein the second direction is opposite the first direction; and turning the first pinion in the first linear gear in the second direction to return the selected cartridge into its respective slot in the cartridge rack.

In some embodiments of the method, the act of drawing further comprises drawing the selected cartridge from its respective slot in the cartridge rack to an unloading position, the unloading position having an edge of the selected cartridge directly above the collection receptacle; and the act of returning further comprises returning the selected cartridge into its respective slot in the cartridge rack.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a medication delivery unit (MDU), according to some embodiments;

FIG. 2A is a side cross-sectional view of an MDU, according to some embodiments;

FIG. 2B is a front cross-sectional view of an MDU, according to some embodiments;

FIGS. 3A-3D are top views illustrating various aspects of a cartridge and cartridge system for an MDU, according to some embodiments;

FIGS. 4A-4D are various view of a collection head for an MDU, according to some embodiments;

FIG. 5 shows a flow diagram of a method for stocking an MDU, according to some embodiments;

FIG. 6 shows a flow diagram of a method of delivering scheduled medications using an MDU, according to some embodiments;

FIG. 7 shows a flow diagram of a method of retrieving pills and delivering them to a patient using an MDU, according to some embodiments; and

FIG. 8 shows a flow diagram of a method of delivering medication on demand to a patient, according to some embodiments.

### DETAILED DESCRIPTION

The inventors have recognized and appreciated the need for an improved in-home medication delivery units (MDU) that can be used in conjunction with support service to improve patient compliance with medication instructions and record keeping of the medicines taken by the patient. The MDU directly controls delivery of medication in pill form and also provides assistance in tracking other forms of medication. The MDU stores pills in cartridges. A gantry system moves a collection head to gather pills from the cartridges at the appropriate times and provides them to the patient.

When discussing the use of MDU reference may be made to a “patient” as the recipient of medication controlled by the MDU. Similarly, reference may be made to a “technician” with respect to stocking and programming the MDU. These titles are exemplary and it should be appreciated that some embodiments of the MDU and related methods may contemplate these roles be performed by the same person or different people. A “user” of the MDU may be a patient, technician, or another individual.

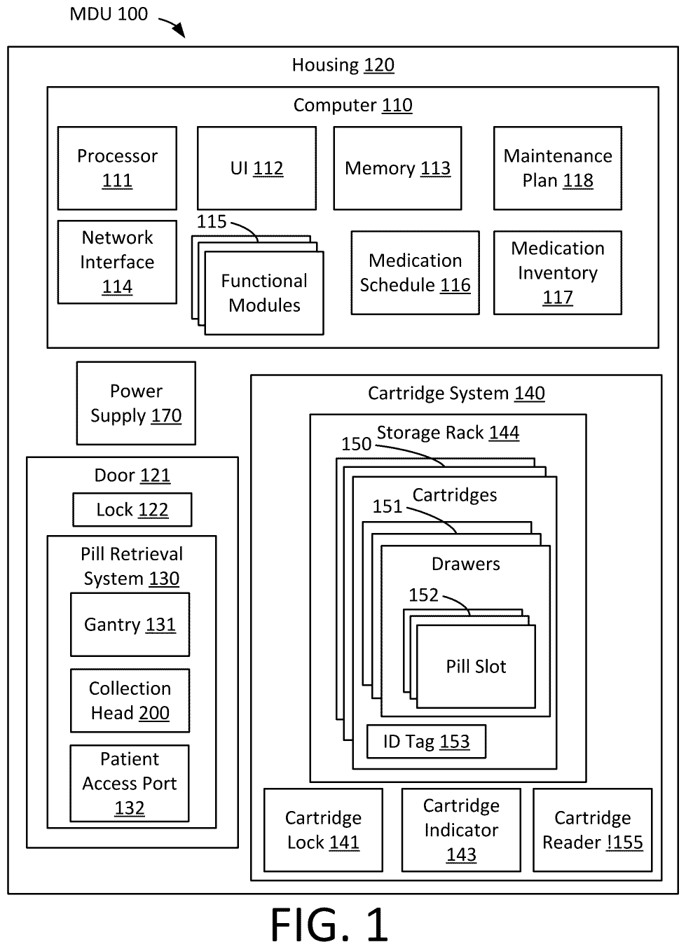

FIG. 1 is a block diagram of an MDU 100 according to some embodiments. MDU 100 has a housing 120 that contains and provides structural support for the various components of MDU 100. While MDU 100 is shown in FIG. 1 with a single housing 120 encompassing all components, it should be appreciated that MDU 100 may be physically realized as a single mechanical enclosure; multiple, operably-connected mechanical enclosures; or in any other suitable way. Housing 120 may be fabricated out of any suitable material or combination of materials.

MDU 100 has a computer 110 for controlling the operations of MDU 100. Computer 110 may include a processor 111, memory 113, UI 112, and network interface 114. Thought, these components are exemplary and computer 110 may have any suitable components or combination of components in other embodiments.

Processor 111 may be configured to control MDU 100 and may be operatively connected to memory 113. Processor 111 may be any suitable processing device such as for example and not limitation, a central processing unit (CPU), digital signal processor (DSP), controller, addressable controller, general or special purpose microprocessor, microcontroller, addressable microprocessor, programmable processor, programmable controller, dedicated processor, dedicated controller, or any suitable processing device. In some embodiments, processor 111 comprises one or more processors, for example, processor 111 may have multiple cores and/or be comprised of multiple microchips. Processing of information, execution or routines, and computations for the operation of MDU 100 may be performed sequentially, in parallel, or by some other method or combination of methods by processor 111.

Memory 113 may be integrated into processor 111 and/or may include “off-chip” memory that may be accessible to processor 111, for example, via a memory bus (not shown). Memory 113 may store computer-executable software modules that when executed by processor 111 perform desired functions. Memory 113 may be any suitable type of non-transitory computer-readable storage medium such as, for example and not limitation, RAM, a nanotechnology-based memory, optical disks, volatile and non-volatile memory devices, magnetic tapes, flash memories, hard disk drive, circuit configurations in Field Programmable Gate Arrays (FPGA), or other semiconductor devices, or other tangible, non-transitory computer storage medium.

Computer 110 may have one or more functional modules 115. Modules 115 may operate to perform specific functions such as collecting, processing, and analyzing data. Modules 115 may be implemented in hardware, software, or any suitable combination thereof. For example, a software functional module or the software portion of a functional module may be stored in memory 113 of computer 110. Such software modules may comprise computer-executable instructions that may be read and executed by processor 111. In some embodiments, a module 115 is implemented at least in part through dedicated hardware (e.g., an A SIC, an FPGA). In some embodiments, modules 115 may share components. For example, a first function module and a second function module may both utilize a common processor (e.g., through time-share or multithreading), have computer executable code stored on a common computer storage medium (e.g., at different memory locations), and/or share computer executable code (e.g., a DLL). In some instances, a module 115 may be identified as a hardware module or a software module. A hardware module includes or shares the hardware for implementing the functionality of the module. A hardware module may include software, that is, it may include a software module. In some embodiments, the information may be used at least in part to configure hardware such as an FPGA. The capability may be implemented, for example, by reading the software module from a storage medium and executing it with one or more processors, or by reading the software module from a storage medium and using the information to configure hardware.

UI 112 may include devices for interacting with the patient, technician, or other user. The devices of UI 112 may include, by way of example and not limitation, keypad, pointing device, camera, display, lights, touch screen, audio input, and audio output. In some embodiments UI 112 includes a speaker to provide an audible announcement of an event requiring a user's attention. In some embodiments, UI 112 includes a strobe light to establish the attention of the patient. In some embodiments, UI 112 includes a display to visually present information to the user. In some embodiments the UI 112 has a touch screen, keypad, or buttons for the user to make selections or enter information into MDU 100. Though, these are simply illustrative examples and UI 112 may include any suitable devices for interacting with the user.

Network interface 114 may be any suitable combination of hardware and software configured to communicate over a computer network. For example, network interface 114 may be implemented as a network interface driver and a network interface card (NIC). The network interface driver may be configured to receive instructions from other components of instrument MDU 100 to perform operations with the NIC. Network interface 114 provides a wired and/or wireless connection to the network. Network interface 114 is configured to generate and receive signals for communication over the network.

MDU 100 may have a power supply 170. Power supply 170 may provide appropriate power to the electrical components of MDU 100. For example, power supply 170 may convert wall power (e.g., 120V AC) to appropriate voltages and current capacities required by MDU 100. In some embodiments, power supply 170 includes a battery backup system to provide operating power, for example, when the primary power source (e.g., wall power) is unavailable.

MDU 100 includes a cartridge system 140 for mechanically managing and electronically interacting with cartridges 150. Cartridge system 140 holds cartridges 150 using a storage rack 144 such that pill retrieval system 130 may retrieve pills from cartridges 150 and make them available to the patient at patient access port 132. Cartridge system 140 may support any suitable number of cartridges 150 for MDU 100.

Each cartridge has one or more drawers 151 and each drawer has one or more pill slots 152 for holding pills. Additionally, each cartridge 150 may have an ID tag 153 for identifying the specific cartridge 150. In some embodiments, ID tag 153 may contain information that identifies the pills (if any) in each pill slot 152 of cartridge 150, or may contain information identifying cartridge 150 that can be referenced to a database on a remote server to determine the contents of cartridge 150. ID tag 153 may be an RFID (“radio frequency identification”), barcode or other optical storage device, a transistor-based storage device (e.g., EEPROM, flash) or any other suitable mechanism for storing and communicating identifying information about cartridge 150 and/or its contents. In some embodiments cartridge 150 also includes markings identifiable to a technician that correspond to information stored by ID tag 153. For example, an ID number may be both printed on cartridge 150 so that the technician may identify the cartridge, and corresponding information (e.g., the same ID number) may be encoded by ID tag 153. Though, in some embodiments the human readable form may serve as ID tag 153 (e.g., cartridge reader 145 utilizes optical character recognition to read the printed ID number).

Cartridge system 140 may include a cartridge lock 141 that prevents a cartridge from being removed or sliding out of storage rack 144 except when permitted by MDU 100. A cartridge indicator 143 may indicate to a technician stocking MDU 100 the location on storage rack 144 where an old (e.g., empty) cartridge is to be removed and/or a new cartridge is to be inserted. In some embodiments, cartridge indicator 143 is a light adjacent to the rack location. In some embodiments each position in storage rack 144 has an identifier (e.g., numbering) and cartridge indicator 143 identify a location by outputting (e.g., visually via a display, audibly via a speaker) to the technician the relevant identifier. Though cartridge indicator 143 may identify a cartridge location in any suitable way.

Cartridge system 140 may have one or more cartridge readers 145 for reading ID tag 153 on a respective cartridge 150. Cartridge readers 145 may be one-to-one with each rack position in storage rack 144 or cartridge reader 145 may be able to read the ID tags 153 of multiple cartridges 150. Cartridge reader 145 may be of a complementary technology for the ID tag 153. For example, if ID tag 153 is an RFID tag, cartridge reader 145 may be an RFID tag reader.

Pills are collected from cartridges 150 by pill retrieval system 130. A gantry 131 positions collection head 200 at the appropriate position for pill retrieval from a respective cartridge 150 and drawer 151. Several pills may be collected from the same cartridge 150 and/or from multiple cartridges 150 by the pill retrieval system 130 prior to making the pills available to the patient via patient access port 132. Once all pills (or the maximum amount of pills) have been collected into the collection head 200, gantry 131 is moved to position the collection head 200 at patient access port 132 for the user to take the retrieved pills.

Pill retrieval system 130 may be located in a door 121 of housing 120 that opens to permits access to cartridge system 140 for a technician to insert and remove cartridges 150 from storage rack 144. A door lock 122 may secure door 122 to the rest of housing 120 in a closed position such that cartridges 150 cannot be accessed (other than by pill retrieval system 130) without a key for door lock 122. Any suitable door lock 122 may be used. In some embodiments, door lock 122 is designed to be fastened and unfastened using a mechanical key. In some other embodiments, door lock 122 is fastened and unfastened using an electronic “key”. In some embodiments, both electronic and mechanical keying are provided for. Though, door lock 122 may be implemented in any suitable way.

In some embodiments, MDU 100 maintains a medication schedule 116. Medication schedule 116 may define the timing and dosage for each medication as well as instructions on how to adjust the medication schedule if, for example, medication is not taken on schedule. It may also include preferences such as avoiding sleeping times or times when the patient is not expected to be near MDU 100. Medication schedule 116 may be stored locally, for example, in memory 113, though in some embodiments, medication schedule 116 is stored on a remote server. If remote, network interface 114 may be used to access medication schedule 116 or to receive push notifications from the remote server when medication is to be taken as well as the necessary details (e.g., medication type, dosage). In some embodiments, both remote and local copies are maintained.

In some embodiments, medication schedule 116 is updated via user interface 112. In some embodiments, ID tag 153 of a cartridge 150 includes medication schedule information that is read by cartridge reader 145 and used to update medication schedule 116. In some embodiments, updates to medication schedule 116 are received via network interface 114. For example, a technician may enter medication schedule information via a remote terminal and the information is disseminated to MDU 100 via its network interface 114 (e.g., over the internet). In some embodiments, medication schedule information is provided in such an interface directly from the pharmacist's information technology infrastructure. In some embodiments, medication schedule information is obtained from a medication label. For example, a medication label may be optically scanned, text on the label may be recognized using an optical character recognition (OCR) software program, and an artificial intelligence (AI) software program may populate the medication schedule 116 based on “reading” the label. A technician may validate the entry to reduce the potential for errors. Further error checking of the medication schedule 116 may be performed using software based on a knowledge base of medications and/or information about the patient. For example, automatic error checking may detect errors in a dosage and frequency by comparing the medication schedule with maximums or minimums specified in a knowledge base. Such built in error checking may be implemented in software at MDU 100 or by software on a remote server. Mechanisms may be put in place to permit overriding errors detected in this way (e.g., a pharmacist “signature” on the exception).

In some embodiments, MDU 100 maintains a medication inventory 117. Medication inventory 117 may be stored in locations analogous to how medication schedule 116 is stored (e.g., in memory 113). Though, medication inventory 117 need not necessarily be stored in the same location as medication schedule 116 and medication inventory 117 may be stored in any suitable way. Medication inventory 117 may be an inventory or both pills stored in cartridges 150 of MDU 100 and medication for the patient that is not inside MDU 100 (e.g., medications requiring refrigeration where MDU 100 does not provide refrigeration). For example, medication inventory 117 may store, for each pill slot 152, in every drawer 151, in every cartridge 150 the type of medication, the amount of medication stored in the pill slot (e.g., “full pill”, “half pill”, “quarter pill”, X milligrams), the expiration date of the medication, the manufacturer of the medication, and the production lot of the medication. Though these are just examples, and any suitable information may be stored in medication inventory 117. For medication not stored inside MDU 100 medication inventory 117 may store, for example, type of medication, patient unit of measure (e.g., X pills, X mL, X syringes), expiration date, physical location (e.g., refrigerator, freezer), and other information appropriate for facilitating a patient in taking the correct medication in the correct amount at the correct time.

Medication inventory 117 may be populated in any suitable way. In some embodiments, initial information for pills stored in a cartridge 150 is stored in ID tag 153 and read by cartridge reader 145 into medication inventory 117 once cartridge 150 is placed in storage rack 144. In some embodiments, information about the contents of a cartridge 150 is stored on a remote server and then populated into medication inventory 117 once the cartridge 150 is loaded into MDU 100. For example, once ID tag 153 is read, network interface 114 queries a remote server as to the contents of the identified cartridge and received the corresponding inventory information. Information about medications not stored in MDU 100 may be entered manually or pushed to MDU 100 from a remote server.

In some embodiments, multiple versions of a medication may be interchangeable or suitable for fulfilling scheduled or on demand medication events. For example, a name brand version of a drug and a generic version of a drug may both be in medication inventory 117. Medication schedule 116 may recognize both the brand name and generic as suitable for satisfying a dosing requirement essentially treating these products interchangeably.

MDU 100 may be periodically stocked by a technician (or other personnel). In some embodiments, MDU 100 has a maintenance plan 118 for managing the timing of restocking, and the removal, placement and replacement of cartridges during restocking. Maintenance plan 118 may be stored in locations analogous to how medication schedule 116 and/or medication inventory 117 are stored. Though, maintenance plan 118 need not necessarily be stored in the same location as medication schedule 116 or medication inventory 117. Maintenance plan 118 may be stored in any suitable way. During a restocking event, cartridges may be removed from, refilled, and/or placed into storage rack 144. Maintenance plan 118 stores information about how maintenance is to be performed so as to assist the technician and provide error checking of the technician's work. Maintenance plan 118 may be generated manually or may be generated automatically or semi-automatically based on medication schedule 116 and medication inventory 117. Maintenance plan 118 may be generated “on demand” meaning the maintenance plan reflects how MDU 100 should be restocked at a particular time. Maintenance plan 118 may reflect knowledge of available medication that is not yet stocked in MDU 100. For example, if a new set of pills have been received this information may be accessible to MDU 100 so that it can determine what portion of these pills should be stocked in MDU 100. Such planning may be particularly beneficial when MDU 100 cannot accommodate all pills that could be stocked.

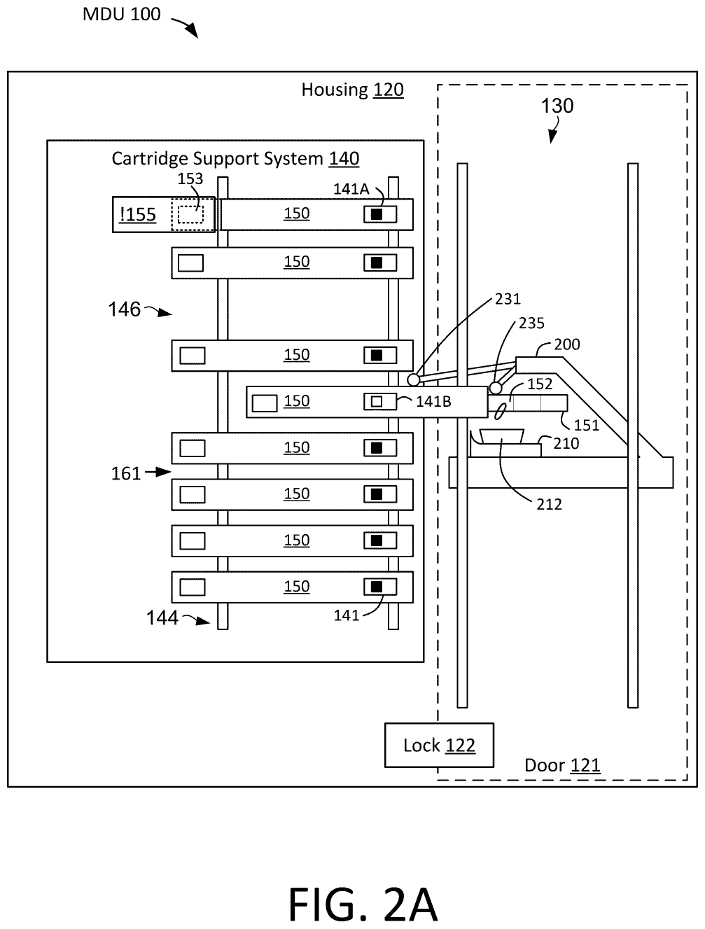

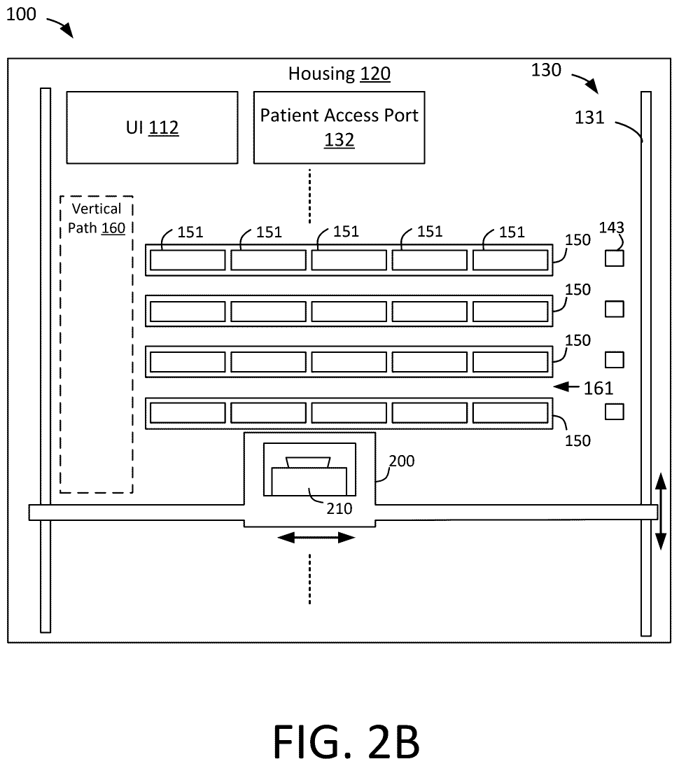

FIGS. 2A and 2B show a side view and a front view according to some embodiments of MDU 100. These figures show an illustrative structure of MDU 100, though the components are not necessarily drawn to scale. Other embodiments may use other structures. FIGS. 2A and 2B are discussed simultaneously, however, not all aspects discussed are illustrated in both figures.

MDU 100 has a cartridge system 140 for maintaining cartridges 150 within MDU 100 and facilitating automated collection of pills from the cartridges. Cartridge system 140 provides a storage rack 144 for supporting cartridges 150 in a stack. While one vertical stack of cartridge 150 is shown in FIGS. 2A and 2B it should be appreciated that in some embodiments cartridge system 140 may support multiple columns of cartridges 150. It should also be appreciated that a cartridge 150 need not be present in each and every position of storage rack 144 for MDU 100 to function. For example, a position 146 in storage rack 144 is shown unoccupied in FIG. 2A.

Cartridge locks 141 secure cartridges 150 into storage rack 144. In the “closed” position (e.g., solid block as in cartridge lock 141A) cartridge lock 141 prevents a racked cartridge from moving out of storage rack 144. In the “open” position (e.g., white block as in cartridge 141B) cartridge lock 141 releases the corresponding cartridge 150 and permits it to slide out of the corresponding rack position. In some embodiments, engaging cartridge lock 141 for a cartridge 150 prevents not only cartridge 150 from sliding out of storage rack 144 it also prevents the drawers 151 of cartridge 150 from opening. Though, drawers 151 may be prevented from undesired opening in any suitable way.

In some embodiments, ID tag 153 is located on the side of cartridge 150 and cartridge reader 145 is positioned to read ID tag 153 for the cartridge. In FIG. 2A ID tag 153 is shown as an RFID tag and cartridge reader 145 is shown as an RFID reader, though any suitable technology may be used. In some embodiments, cartridge readers 145 may be at every cartridge position, while in other embodiments a smaller number of cartridge readers 145 may be used (e.g., 1 reader for all cartridges).

Gantry 131 of pill retrieval system 130 may position collection head 200 at the location desired for pill retrieval. Gantry 131 may move vertically and laterally such that collection head 200 may be positioned at the correct cartridge 150 and drawer 151 for the desired pill. In some embodiments, gantry 131 utilizes two belts and associated drivers and supports to position collection head 200 at the desired location. In some embodiments, gantry 131 utilizes lead screw linear actuators to position collection head 200 at the desired location. Though any suitable positioning technology or combination of technologies may be used for positioning collection head 200.

In some embodiments, the movement of collection head 200 by gantry 131 is controlled to prevent collision between components of collection head 200 and cartridges 150. For example, cartridge pinion 231 may extend over cartridges 150 so that it can be engaged with a rack on a cartridge 150 by lowering cartridge pinion into such rack. Gantry may move collection head 200 such that, except for when cartridge pinion 231 is to be engaged with a cartridge 150, cartridge pinion 231 travels in vertical path 160 and gaps 161 between adjacent cartridges 150.

Collection head 200 may draw the cartridge out over a pill receptacle 210 such that when drawer 151 is opened the pill will be gravity fed into pill receptacle 210. In some embodiments pill receptacle 210 holds a removal pill cup 212 for holding pills 10. Though pill receptacle 210 may be shaped to collect pills regardless of whether pill cup 212 is present. In some embodiments pill receptacle 210 includes a sensor for detecting the presence or absence of pill cup 212. Once the appropriate cartridge 150 has been drawn to the appropriate position, collection head 200 may draw out drawer 151 to the pill slot 152 containing the pill. If more than one pill is required from the same drawer, drawer 151 may be withdrawn further to allow the pill in the subsequent pill slot 152 to fall into pill receptacle 210. It should be appreciated that in some embodiments it is unnecessary to draw cartridge 150 from storage rack 144 prior to drawing one of its drawers 151 to collect a pill. For example, pill receptacle 210 may be moved away from cartridges 150 during gantry movement to avoid interference, and then moved close to a selected cartridge 150 during pill collection, thus avoiding a step of drawing out cartridge 150.

Once all required pills from the selected drawer 151 have been collected, drawer 151 is closed and the selected cartridge 150 is fully returned to storage rack 144. If a pill from another drawer 151 is required, gantry 131 moves collection head 200 to the next drawer position, and the process is repeated. Once all pills to be collected have been retrieved gantry 131 positions collection head 200 at patient access port 132 where the user may gather the collected pills. Patient access port 132 may itself have a door that is automatically closed at times collection head 200 is away from patient access port 132 and opened at times collection head is at patient access port 132.

In an example use case, a user interface (UI) of the MDU notifies the patient when it is time to take medication prompting, if applicable, the patient to trigger collection of the pills and delivery of the pills from the unit to the patient.

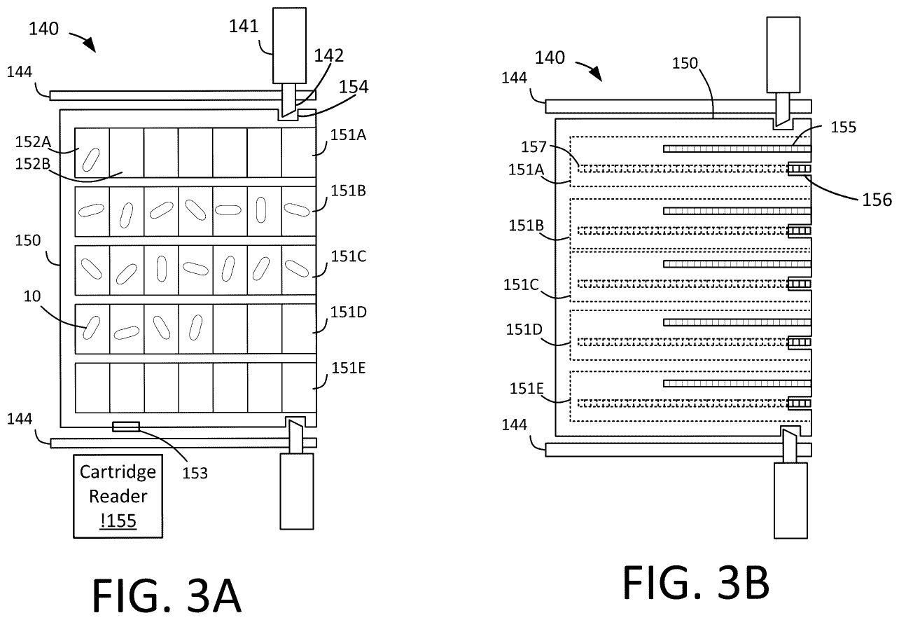

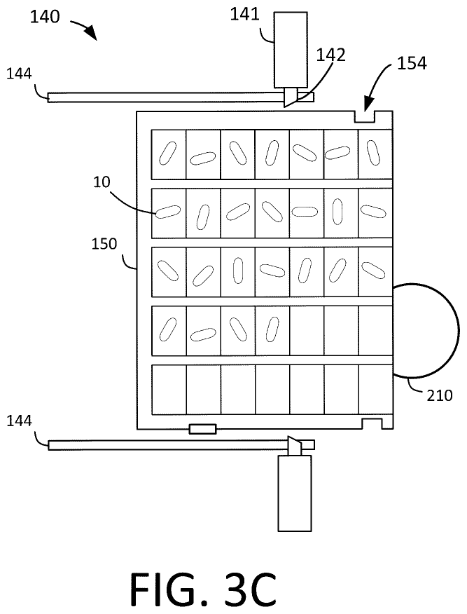

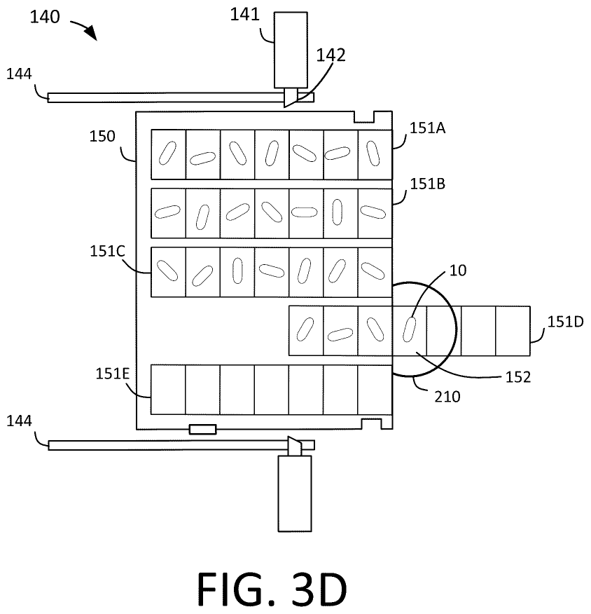

Some embodiments of cartridge 150 in cartridge system 140 are presented with reference to FIGS. 3A-3D. FIG. 3A shows a top view of cartridge 150 mounted in storage rack 144. Storage rack 144 is represented as guide rails onto which cartridge 150 is inserted, but this is simply illustrative and any suitable mechanism for securing cartridge 150 may be used. Cartridge 150 is shown with drawers 151A-151E. Five drawers are shown as an illustrative embodiment and cartridge 150 may have any suitable number of drawers including but not limited to 1, 2, 3, 4, 5, 6, 7, 8, 9, and 10 drawers 151. Each drawer has a suitable number of pill slots such as pill slots 152A and 152B in in drawer 151A. For example, and not limitation each drawer may have 1, 2, 3, 4, 5, 6, 7, 8, 9, 10, 11, 12, 13, 14, 15, 16, 17, 18, 19, 20, 21, 22, 23, 24, 25 or any other suitable number of pill slots 152. In some embodiments pill slots 152 are substantially equal in size while in some other embodiments different pill slot sizes may be present in a single drawer, drawers may have different pill slot sizes with a common cartridge, or cartridges may each have a single size pill slot but different cartridges may have different size pill slot. Though these are just examples, and the pill slots may be partitioned in any suitable way.

Cartridge lock 141 holds or releases cartridge 150 in/from storage rack 144. Cartridge lock 141 may be controlled by computer 110. In the illustrated embodiment there are two cartridge locks 141 per cartridge 150 located on opposite lateral sides of the cartridge. Cartridge lock 141 may be, for example, a linear solenoid that pushes or pulls a lug 142 into and out of a catch 154 on cartridge 150. In some embodiments a linkage may be used to convert the linear motion of the solenoid to another direction; for example, cartridge lock 141 may be a solenoid that provides linear motion in the direction of cartridge insertion and a linkage may convert this motion to move lug 142 in the lateral direction in and out of catch 154. Other suitable cartridge locks may be utilized such a clamp that secures cartridge 150 in storage rack 144 by applying a suitable force (e.g., against the top and bottom of cartridge 150 and/or against the lateral sides of cartridge 150), a hook to hold cartridge 150 in storage rack 144 (e.g., on the rear face of cartridge 150 opposite drawers 151), or in any other suitable way or combination of ways. In some embodiments a single cartridge lock 141 is user per cartridge 150, though any suitable number of cartridge locks 141 may be used. In some embodiments cartridge lock 141 secures cartridge at one or multiple points. For example, a suitable linkage between the actuator component of cartridge lock 141 and the securing mechanism (e.g., lug, hook, clamp) may be utilized to provide multiple securing point. In some embodiments cartridge lock 141 also secures drawers 151 in the corresponding cartridge 150 so they do not inadvertently slide out. Though, other mechanisms may be used to secure drawers 151 within cartridge 150.

FIG. 3A also shows an illustrative embodiment of ID tag 153 and cartridge reader 145.

FIG. 3B shows some other aspects of a cartridge 150 in cartridge system 140, according to some embodiments. In this illustration, a top view of cartridge 150 is shown. Dashed lines are used to show features of drawers 151A-151E that may be hidden by the top surface of cartridge 150 in such a view. Each drawer has an associated cartridge linear gear 155 and a drawer linear gear 157. The top surface of cartridge 150 may have a notch 156 to permit a drawer pinion 235 of collection head 200 to engage drawer linear gear 157. Cartridge linear gear 155 may be engaged by a cartridge pinion 231 of collection head 200 to draw cartridge 150 out of storage rack 144. The length of rack 155 should be sufficient to permit the pinion to draw cartridge 150 out of storage rack 144 such that the front face of cartridge 150 is over pill receptacle 210. After the desired pills have been collected from cartridge 150, cartridge linear gear 155 may be used to return cartridge 150 to storage rack 144. FIG. 3C shows cartridge 150 drawn out of storage rack 144 over pill receptacle 210. Note that prior to withdrawing cartridge 150 from cartridge 150 cartridge lock 141 is released (in this example embodiment withdrawing lug 142 from catch 154).

Drawer linear gear 157 may be engaged by a drawer pinion 235 of collection head 200 to draw the corresponding drawer 151 from cartridge 150. The length of rack 157 should be sufficient to allow a pill in the last pill slot 152 in drawer 151 to be retrieved. After the desired pills from a selected drawer have been deposited in pill receptacle 210, drawer linear gear 157 may be utilized to return the corresponding drawer 151 fully into cartridge 150. FIG. 3D shows drawer 151D drawn from cartridge 150 to allow pill 10 to fall from pill slot 152 into pill receptacle 210.

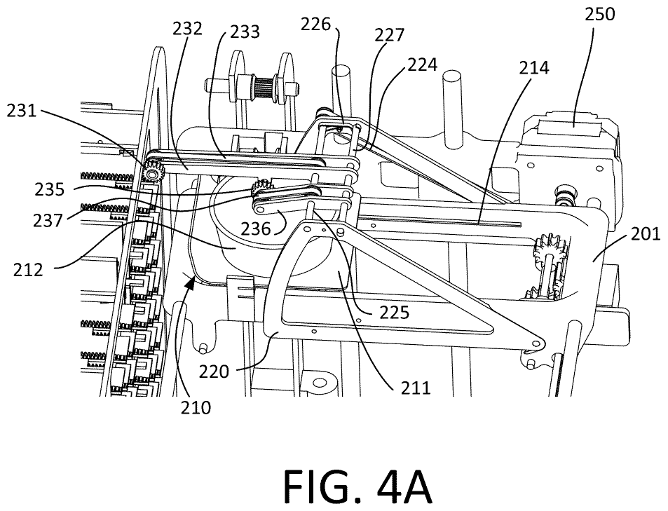

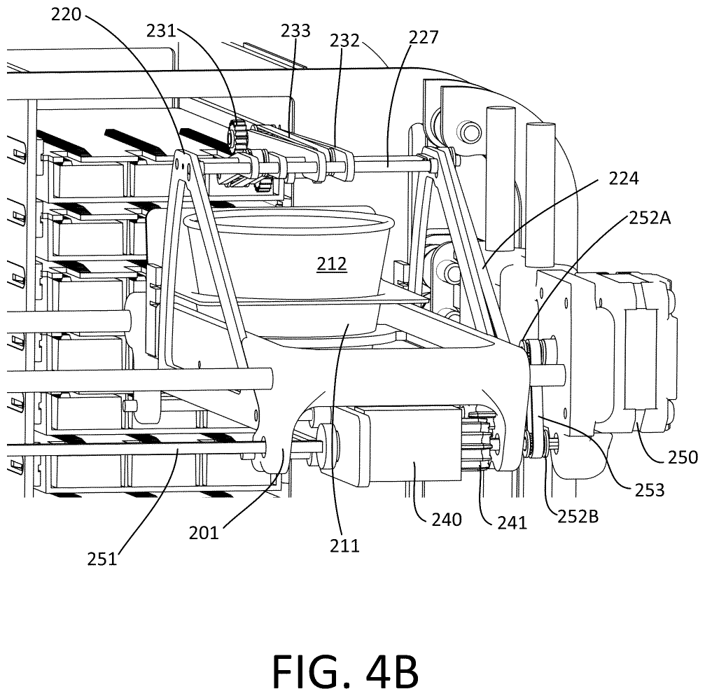

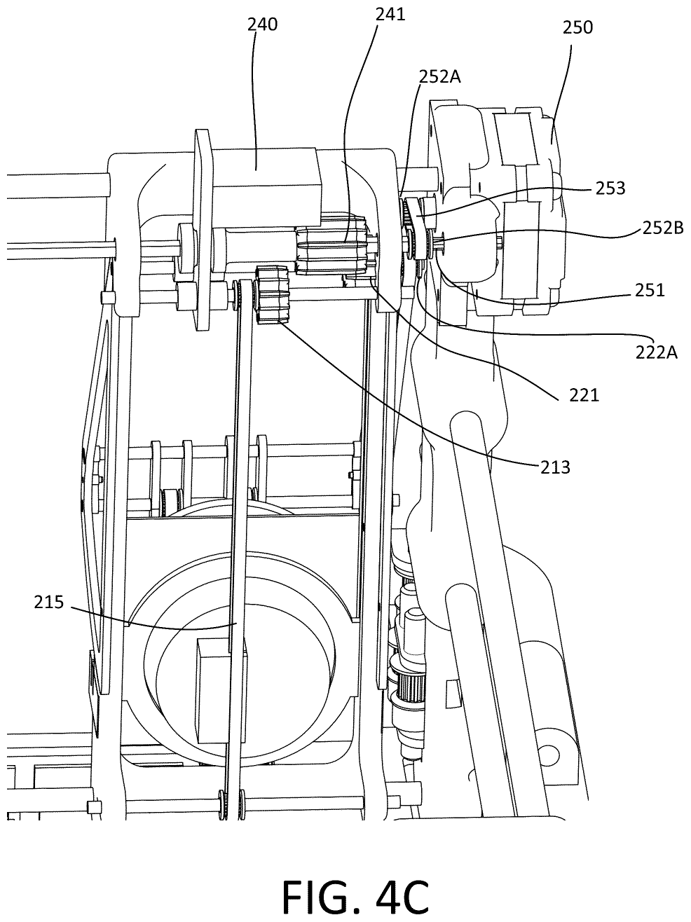

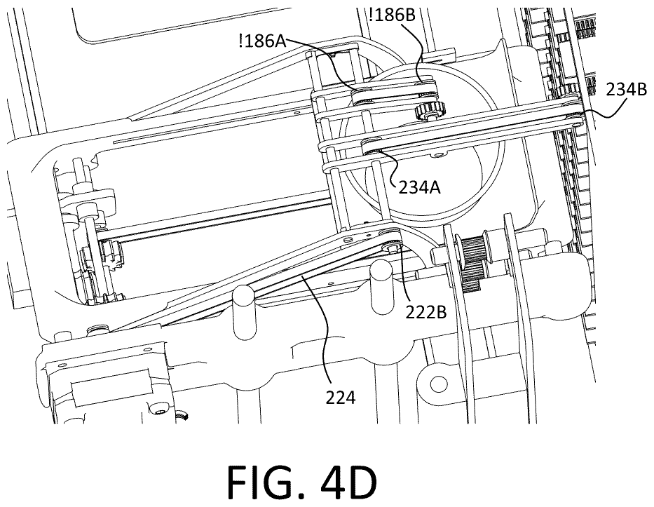

Attention is now turned to FIGS. 4A-4D which show views of a collection head 200, according to some embodiments. Some of the views show additional aspects of pill retrieval system 130 and cartridge system 140 for context. For visual clarity, some features that may be present in some embodiments of MDU 100, such as belts for gantry 131, are not shown. Collection head 200's functions include (i) drawing cartridge 150 from storage rack 144 so that pills may be deposited in pill receptacle 210, (ii) returning cartridge 150 to storage rack 144 after pill retrieval, (iii) drawing a drawer 151 to the proper pill slot 152, (iv) returning the drawer fully into the cartridge, and (v) positioning pill receptacle 210 at patient access port 132 for pill retrieval by the patient.

Collection head 200 has a collection head body 201 to which various components are attached to facilitate these actions.

In the illustrated embodiment of collection head 200, two actuators are used for operation. Collection head drive motor 250 drives cartridge pinion 231, drawer pinion 235, and moves pill receptacle 210. In some embodiments drive motor 250 is a stepper motor, though any suitable motor for turning main drive axel 251 may be used. Collection head drive motor 250 is attached to main drive axel 251 which turns drive gear 241. In some embodiments, main drive axel 251 is offset from the axel of drive motor 250. In some such embodiments, a gear 252A is connected to drive motor 250's axel, a gear 252B is connected to main drive axel 251, and a belt 253 therebetween is used to transfer motion. Though, this is simply an example, and drive motor 250 may drive main drive axel 251 in any suitable way. Drive gear 241 can engage pinion drive gear 221 to drive cartridge pinion 231 and drawer pinion 235 or it can engage pill receptacle drive gear 213 to drive the position of pill receptacle 210. A selection actuator 240 may be used to move drive gear 241 to engage with one or the other. Selection actuator 240 may be a linear motor, a solenoid or any other suitable actuator for moving drive gear 241 between pinion drive gear 221 and engage pill receptacle drive gear 213. In some other embodiments one motor is dedicated to driving cartridge pinion 231 and drawer pinion 235 and another motor is used to drive the position of pill receptacle 210. In another embodiment, separate motors are used to drive each pinion. It should be appreciated that these embodiments are illustrative and other embodiments may utilize any suitable number or type of actuators for operation of collection head 200.

Pill receptacle 210 may be moved by pill receptacle drive belt 215 between a first position for receiving pill(s) 10 and a second position where the pill(s) 10 collected into pill receptacle 200 may be collected by a patient via patient access port 132. When drive gear 241 is engaged with pill receptacle drive gear 213, turning of drive gear 221 may cause pill receptacle drive belt 215 to move. Pill receptacle 210 may be attached to pill receptacle drive belt 215 such that pill receptacle 210 is moved linearly with the movement pill receptacle drive belt 215. Though pill receptacle 210 may be engaged to move in any suitable way. In some embodiments, pill receptacle 210 is stationary and both functions of receiving pills 10 from cartridges 150 and making pills 10 accessible to a patient via patient access port 132 are achieved from the same position. In some embodiments, pinion support structure 220 is moved to permit retrieval of pills without independently moving pill receptacle 210.

When drive gear 241 is engaged with pinon drive gear 221, turning drive gear 241 causes main pinion drive belt 224 to turn. Pinion drive axel gear 222B at the distal end of pinion drive belt 224 is axially mounted on pinion drive axel 225 which itself is supported by pinion support structure 220. Pinion support structure 220 may be hingedly connected to collection head body 201. The pivot point for pinion support structure 220 is about the axis of pinion drive axel gear 222A which is co-axial with pinion drive gear 221 so that rotation of pinion support structure 220 does not affect the tension of pinion drive belt 224. Gears 234A and 238A are secured to pinion drive axel 225. Cartridge pinion drive belt 233 and drawer pinion drive belt 237 are turned by gears 234A and 238A, respectively. Cartridge pinion drive belt 233 and drawer pinion drive belt 237 are connected at the distal end and turn gears 234B and 238B, respectively. Cartridge pinion 231 is axially connected to gear 234B such than when gear 234B is turned by cartridge pinion drive belt 233 cartridge pinion 231 is turned. Similarly, drawer pinion 235 is axially connected to gear 238B such than when gear 238B is turned by drawer pinion drive belt 237 drawer pinion 235 is turned. Gear 234B and cartridge pinion 231 are held in position by cartridge pinion support structure 232. Gear 238B and drawer pinion 235 are held in position by drawer pinion support structure 220. The relative positions of cartridge pinion support structure 232 and drawer pinion support structure 220 may be fixed so that any rotation of the support structures about pinion drive axel 225 is the same for both. A pinion spring 226 draws drawer pinion support structure 236 and cartridge pinion support structure 232 down so that the respective pinions are able to engage in the respective racks. Pinion spring 226 is mounted on support bar 227 which is confined by pinion support structure 220.

To draw a cartridge 150 from storage rack 144, collection head 200 is first positioned at a desired cartridge 150 and drawer 151 by gantry 131. When moving vertically between cartridges 150, gantry 131 first moves collection head 200 to vertical path 160 to prevent cartridge pinion 231 from catching on cartridges 150 or other hardware in cartridge system 140 (see FIG. 2B). Vertical path 160 is a space providing clearance for vertical movement of collection head 200. When moving laterally, gantry 131 moves collection head 200 such that cartridge pinion 231 clears within the gap 161 between cartridges 150 in storage rack 144. Finally, once collection head 200 is at the desired cartridge 150 and drawer 151, collection head 200 is moved down to allow cartridge pinion 231 to contact cartridge linear gear 155. Pinion spring 226 provides a downward force for engaging cartridge pinion 231 into cartridge linear gear 155.

With drive gear 241 engaged in pinion drive gear 221, collection head drive motor 250 causes cartridge pinion 231 to turn engaging it with cartridge linear gear 155. With cartridge pinion 231 engaged with cartridge linear gear 155, turning cartridge pinion 231 draws cartridge 150 out from storage rack 144. Once cartridge 150 has been drawn over pill receptacle 210, drawer pinion 231 will engage drawer linear gear 157. Once drawer pinion 231 engages with drawer linear gear 157 it causes drawer pinion support structure 220, and thus cartridge pinion support structure 232, to rise slightly disengaging cartridge pinion 231 from cartridge linear gear 155. To draw and return a drawer 151 from cartridge 150, collection head 200 has a drawer pinion 235 that engages drawer linear gear 157. Drawer pinion 235 is held in place by drawer pinion support structure 236 which is also attached to pinion drive axel 225. Drawer pinion support structure 236 and cartridge pinion support structure 232 are mechanically connected to one another with drawer pinion support structure 236 slightly lower to ensure that once drawer pinion 235 engages drawer linear gear 160, cartridge pinion 231 disengages from cartridge linear gear 155. Drawer 151 is then drawn out until the desired pill slot 152 is reached and the associated pill 10 is deposited in pill receptacle 210.

To return drawer 151 to cartridge 150, collection head drive motor 250 is turned in the oppositive direction such that drawer pinion 155 pushes drawer 151 back into cartridge 150. Once drawer 151 is fully returned to cartridge 150, drawer pinion 235 is forced down by pinion spring 226 causing cartridge pinion 231 to engage cartridge linear gear 155. Collection head drive motor 250 continues to turn, causing cartridge pinion to turn and return cartridge 150 to storage rack 144 at which time collection head drive motor 250 is stopped.

It should be appreciated that while both the cartridge/drawer drawing function and the pill receptacle 210 function have been described as being achieved in front of the cartridges 150, these functionalities may be achieved in any other suitable way. For example, cartridges 150 and drawers 151 may be pushed out rather than pulled out by positioning the pinions at the rear of the cartridges 150 while keeping pill receptacle 210 in front.

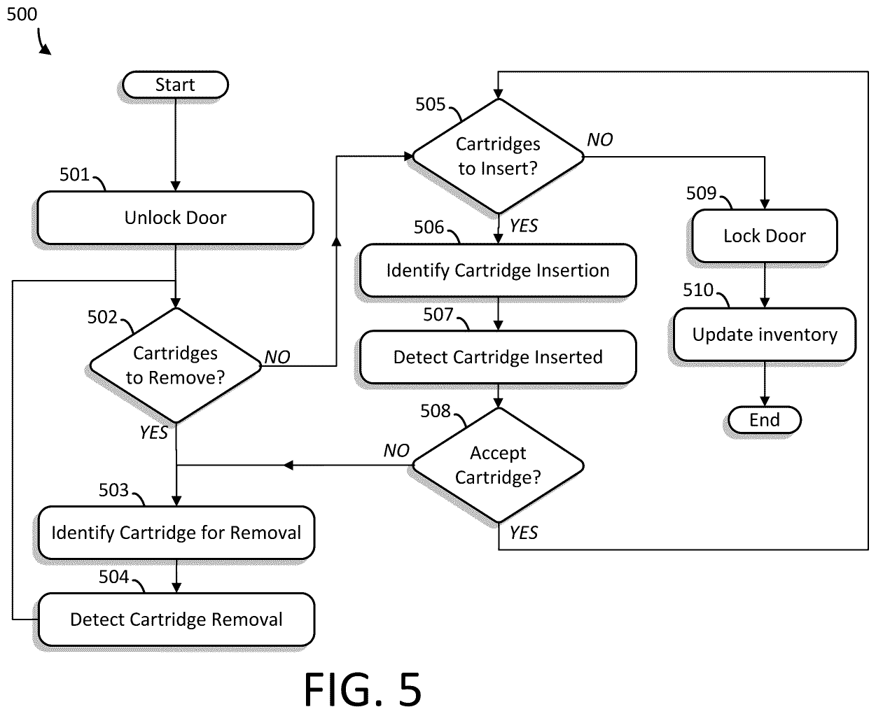

Having described some embodiments of the electrical and mechanical structure of MDU 100, attention is now turned to several methods that may be used to operate MDU 100. These methods are discussed with reference to FIGS. 5, 6, 7, and 8. Instructions for these methods may be recorded in computer-executable code that when executed cause MDU 100 to perform the applicable actions. For example, such computer-executable code may be stored as one or more functional modules 115 recorded in memory 113. When such functional modules 115 are then executed by processor 111 the corresponding actions are taken by the various components of MDU 100. Though, this is just exemplary, and the methods may be implemented in any suitable way. The method steps described may be executed in a different order than that illustrated in the drawings. Further some steps may be absent from some embodiments and other steps may be present. Some steps shown being performed serially may be performed in parallel, and similarly, some steps shown and being performed in parallel may be performed serially.

FIG. 5 shows a flow diagram of a method 500 of stocking MDU 100 with pills, according to some embodiments.

At step 501, method 500 unlocks door lock 122 allowing door 121 to be opened. MDU 100 may unlock door 121 in response to a mechanical key in door lock 122, in response to an electrical signal, or as a result of any suitable unlocking trigger. In some embodiments information (e.g., password, retinal scan, fingerprint ID) is entered via UI 112 to unlock the door. In some embodiments a FOB is used to unlock the door. In some embodiments a remote application communicating with MDU 100 via network interface 114 is used to unlock the door (e.g., a smartphone app). In some usage scenarios, the “key” is limited to technician(s) responsible for stocking MDU 100 with pills and direct patient access is not permitted. Though, in some other usage scenarios MDU 100 may be stocked by the patient.

At step 502 a determination is made whether there are cartridges to be removed. Cartridges may be removed because, for example, they are empty; the pills have expired; the medication is no longer prescribed for the patient; the cartridge, even if partially full, must be refilled; or any other suitable reason. The determination may be made, for example, based on medication schedule 116 and medication inventory 117. For example, a cartridge 150 may be partially full and insufficient to medicate the patient through the next scheduled refill of the MDU. In such case the cartridge may be determined to be removed so it can be “topped off” by the technician. In some embodiments, a remote server pushes instructions to the MDU about what cartridges should be removed. Though, the determination of whether there are cartridges to be removed may be made in any suitable way. An affirmative determination that there is a cartridge 150 to be removed causes method 500 to proceed to step 503 while a negative determination causes method 500 to proceed to step 505.

If at step 502 it is determined that there are cartridges to be removed, method 500 proceeds to step 503 at which method 500 identifies to the technician a specific cartridge for removal. The method may cause cartridge indicator 143 to indicate the cartridge 150 to be removed. Though, an indication of which cartridge 150 to remove may be provided in any suitable way.

At step 504 method 500 detects whether indicated cartridge 150 has been removed. For example, cartridge reader 145 maybe monitored for the rack position of such cartridge 150 to be removed. If cartridge reader 145 indicates that there is no cartridge present, method 500 may determine that the appropriate cartridge 150 has been removed. Though detection of cartridge removal may be performed in any suitable way. After step 504 method 500 returns to step 502 to determine if further cartridges 150 are to be removed.

It should be appreciated that the cartridge removal process may include additional error checking. For example, error checking may be performed to verify that cartridges that are not to be removed have not been removed. In some embodiments, cartridges to be removed are all identified at the same time (e.g., all cartridge indicators for cartridges to be removed are simultaneously illuminated). In some embodiments, method 500 does not manage cartridge removal and relies solely on the technician to perform this task.

Once it is determined at step 502 that there are no (further) cartridges 150 to be removed, method 500 proceeds to step 505 where a determination is made as to whether there are cartridges 150 to insert into storage rack 144. Such a determination may be made based on a maintenance plan. If there are cartridges to insert, method 500 continues to step 506; otherwise, method 500 continues to step 509.

At step 506 method 500 identifies the next cartridge 150 to be inserted. In some embodiments, MDU 100 outputs a cartridge ID on UI 112 (e.g., on screen, audibly) and indicates the correct rack location via cartridge indicator 143.

At step 507, method 500 detects the cartridge has been inserted. This may be achieved for example, by detected by being able to obtain a new reading of an ID tag 153.

At step 508 method 500 determines if the inserted cartridge 150 is to be accepted. Error checking may include verifying that the cartridge 150 has been inserted at the desired rack position and that the cartridge ID read from ID tag 153 matches the expected cartridge ID. If it is determined that the correct cartridge 150 has been inserted at the correct rack position, method 500 continues by returning to step 505. If the cartridge is not to be accepted, method 500 returns to step 503 so that the inserted cartridge can be identified for removal.

Steps 505, 506, 507 and 508 repeat until all cartridges to be inserted have been properly inserted at which point step 505 will determine that there are no (further) cartridges to insert and proceed to step 509. At step 509 the door is relocked.

At step 510 medication inventory 117 is updated based on the contents of the cartridges 150 in cartridge system 140. Method 500 ends and MDU 100 is ready for patient use.

In some embodiments restocking is passively achieved, the technician having complete control over how and where pills are stocked. Once stocked the MDU may estimate based on the medication schedule and updated medication inventory when the MDU will need to be restocked. Active restocking is intended to practically minimize the frequency of technician visits (i.e., practically maximize the amount of time between technician visits) where “practically” means that minimize and maximize need not be theoretical limits, merely practical limits that can be achieved based on limited information, uncertainty, and limited algorithmic scheduling sophistication. Active restocking also may, for example, seek to minimize the amount of time spent by the technician restocking MDU 100 and/or to minimize the collection time of pills during operation by positioning pills that are to be administered at the same time near each other so that the gantry system can have practically minimized movement.

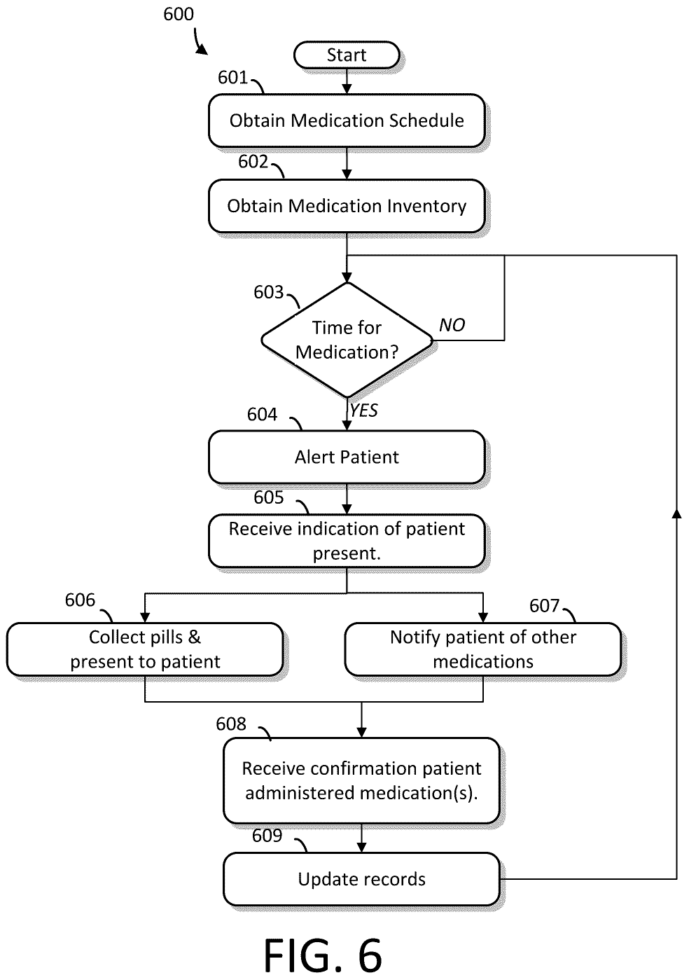

FIG. 6 shows a flow diagram of a method 600 of delivering scheduled medications using MDU 100.

At step 601, access to medication schedule 116 is obtained. Such access may require access to a remove server or may be as a result of local storage of medication schedule 116 (e.g., in local memory of MDU 100).

At step 602, access to medication inventory 117 is obtained. Access may be obtained, for example, in similar ways as access was obtained to medication schedule 116.

At step 603 a determination is made whether it is time for medication based on medication schedule 116. This may be determined by comparing a current time to a time of the next scheduled dose of each mediation being taken by the patient. If the current time is the same or after the time of the next scheduled dose of any medication in medication schedule 116 a positive determination may be made. In some embodiments doses are grouped such that multiple medications may be taken at the same time by a patient.

If it is determined at step 603 that it is time for medication, method 600 proceeds to step 604 where an alert is put out for the patient. The alert may utilize any suitable output of the user interface portion of MDU 100. In some embodiments, a patient alert is pushed to a second device such as a smart phone, TV, or another electronic device associated with the patient.

At step 605 an indication of the patient's presence at the MDU is received. The patient's presence may be detected, for example, by a sensor that detects a pill cup 212 being placed in the pill receptacle, a button press by the patient on UI 112 of MDU 100, or in any other suitable way.

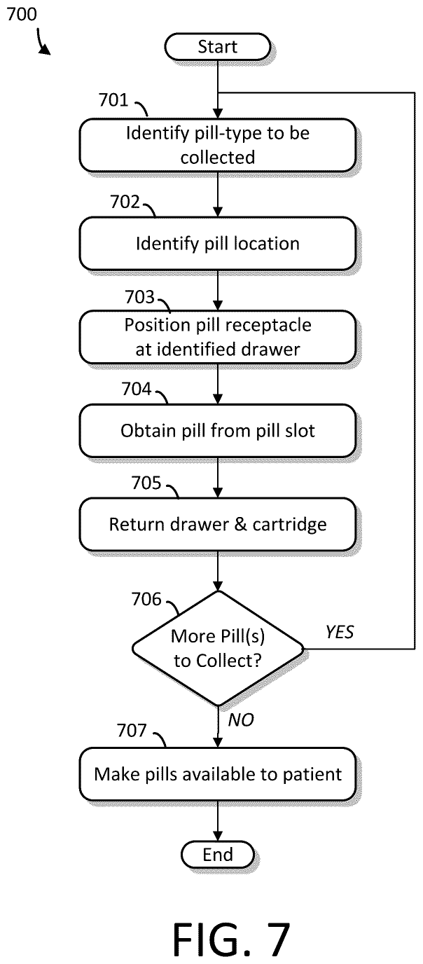

After confirming the patient's presence, if there are pills to collect from MDU 100 method 600 performs step 606 where pills are collected from the MDU. In some embodiments, pill collection is performed in accordance with method 700 discussed in connection with FIG. 7, though pill collection may be performed in any suitable way.

After confirming the patient's presence, if there are other medications not located in MDU 100 that the patient is to take at the present time, method 600 performs step 607. Step 607 may be performed at the same time as 606 or in sequence with step 606. At step 607, MDU 100 informs the patient of additional medications that should be presently taken. The patient may be notified of such other medications in any suitable way. For example, user interface 112 of MDU 100 may indicate via a display and/or output via a speaker the medications to be taken, the quantity to be taken, and the location of the medication.

After method 600 has provided pills (at step 606) and/or other medications (at step 607) to the patient, method 600 may proceed to step 608 where it awaits and receives confirmation that the medication has been taken by the patient. For pills provided by MDU 100 where a pill cup is placed in the pill receptacle, a sensor signal detecting removal of the pill cup from the pill receptacle may be deemed confirmation with respect to the pills. In some embodiments, confirmation may be detected via a button press or other input from the user to MDU 100. In some embodiments more detailed confirmation may be required. If the patient fails to provide feedback in a set amount of time, MDU 100 may proceed to the step 609 noting the lack of confirmation in memory 113. MDU 112 may seek confirmation at a later time, for example, as part of step 605 at the next medication time.

At step 609 a record is updated recording the times, amounts, types and any other suitable information about the medication taken by the patient. For example, medication schedule 116 may be updated by computer 110 to store such historical information. Medication inventory 117 may be updated based on the pills that have been removed from cartridges during step 606 and the prescribed dosage consumed of the other medications, if any. These records may be electronically accessible to the patient, to the patient's healthcare providers and pharmacists, and to the technicians responsible for stocking MDU 100 so that each may better fulfil their role in the patient's health.

After step 609, method 600 returns to step 603 where the cycle repeats. In performing step 603 periodic updates to the medication schedule may be taken into consideration. Method 600 may “restart” for example, when the door to the MDU is opened and medication added to inventory.

FIG. 7 shows a flow diagram of a method 700 of retrieving pills and delivering them to a patient using MDU 100, according to some embodiments. Method 700 is presented as a looping method that continues until all pills to be taken at the present time have been collected. It should be appreciated that in some other embodiments, all pills to be collected are considered simultaneously and the information is utilized to achieve a practically efficient collection route.

At step 701, method 700 identifies the type of pill to be collected. The type of pill to be collected is determined from the medication schedule. If there are multiple types of pills to be collected the loop may pick which type of pill to collect in a given loop any suitable way. For example, based on the order the prescription was added to the medication schedule.

At step 702 identifies a location of a pill to be collected within the MDU. As the MDU has access to and/or maintains a medication inventory, there may be several acceptable pills to be collected. For example, the MDU may have 30 of the same type of pill (i.e., same medicine and same dosage). The accessible pills may be limited to the first available pill in each drawer. That is, a pill in a pill slot further from the front of a drawer cannot be accessed until all pills in pill slots closer to the front of the drawer have been withdrawn. Accordingly, selection of pills may be limited to accessible pills. Among the accessible pills of the same type, the MDU may identify which pill to collect in any suitable way. For example, MDU 100 may work through a cartridge 150 in a prescribed order; the MDU may select the pill in the closest pill slot containing such pill; or the MDU may select the pill requiring the least amount of movement of the collection head for all pills in the batch. Of course, if there is only one pill of the desired type accessible, such pill must be selected. These are just examples and any suitable algorithm may be utilized for identification of the pill to be collected.

After identifying a pill to be collected, step 703 of method 700 moves the collection head such that the pill receptacle 210 is located at the correct drawer 151. For example, a gantry 131 system may be used to move the collection head.

With the pill receptacle in position, step 704 first draws the corresponding cartridge 150 out of the storage rack 144 of the cartridge system 140 and then draws the drawer 151 to the desire pill slot 152 resulting in the pill 10 in that pill slot dropping into the pill receptacle 210.

At step 705 the drawer and cartridge are returned to the cartridge system's rack.

Method 700 then proceeds to step 706 and determines if there are more pills to collect. If so, method 700 returns to step 701 and the process repeats. If not, method 700 continues to step 707. A side from basing the decision on the medication schedule, step 706 may consider whether the pill receptacle is full and temporarily proceed to step 707 if the pill receptacle may not be able to accommodate further pills. Thereafter method 600 could return to step 701 to collect any remaining pills.

At step 707 the pill receptacle is moved to the patient access port of the MDU where the patient can retrieve the collected pills from the MDU. After completion of step 707 method 700 ends.

It should be appreciated that other embodiments of method 700 may utilize more sophisticated decision making such as to, for example, reduce collection time and reduce wear-and-tear on the mechanical systems. For example, in another embodiment of method 700, after a pill is obtained from a pill slot 152 at step 704 and prior to returning the drawer and cartridge at step 705, method 700 may, determine if the pill in the next pill slot in the same drawer should be collected. If so, the drawer can simply be drawn to the next pill slot to collect the next pill avoiding the extra closings of the drawer and cartridge. Further, it should be appreciated that considering the entire batch of pills to be collected simultaneously may permit significantly faster collection since not only the location of pills but also the order of pills may be considered.

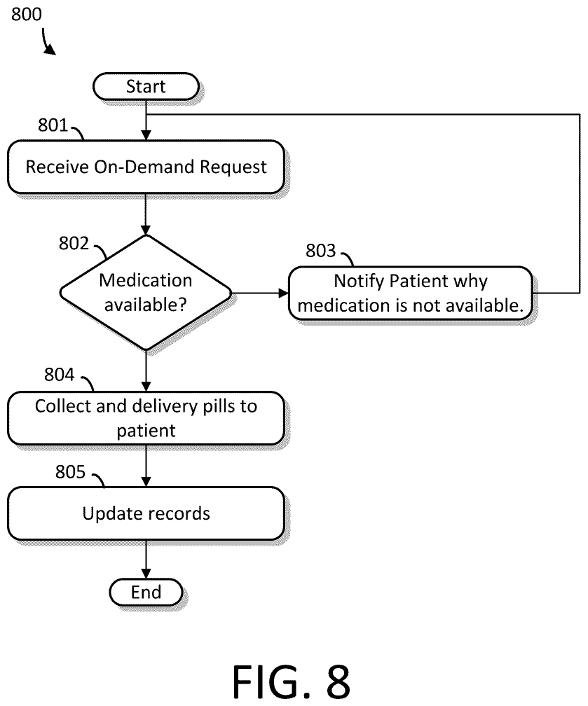

In addition to scheduled medications a patient may have prescriptions to take medication on an “as needed” (unscheduled) basis. To accommodate such delivery, MDU 100 through its user interface 112 may provide an option for a patient to request such medication. For example, a display portion of user interface 112 may list such medications (optionally in a patient friendly format—e.g., by drug function rather than or in addition to drug name) for selection by the patient. FIG. 8 shows a flow diagram of a method 800 of delivering medication on demand to a patient, according to some embodiments.

At step 801 a on-demand request is received by MDU 100. This request may come through the user interface 112 or in any other suitable way. The request may explicitly or implicitly identify both the type of medication and the dosage being requested.

After received the request, method 800 continues to step 802 where it is determined if the requested medication is available. The medication may be unavailable, for example, because (i) the medication is not physically present (e.g., no pills left in MDU; no medication outside MDU), (ii) the requested dosage is too large, and/or (iii) not enough time has elapsed since the prior dose was provided. Thought these are just examples, and method 800 may determine the requested medication is unavailable for any suitable reason. The medication may be determined to be available if none of the impediments to making the medication available to the patient are present.

If step 802 determines that the medication is not available, method 800 proceeds to step 803. At step 803 the patient is notified that the medication is not available. The notice may be provided, for example, through UI 112 of MDU 100. In some embodiments a reason is provided and/or an indication of under what conditions the medication would be available (e.g., available in 1 hour; available in smaller dosage).

Alternatively, if step 802 determines that the medication is available, method 800 proceeds to step 804. At step 804 the medication may be collected and delivered to the patient (as applicable). Step 804 may be implemented in ways similar with those discussed in connection with steps 606 and 607 discussed in connection with FIG. 6, and method 700 as discussed in connection with FIG. 7. Step 804 may include confirming that the patient actually took the medication requested (for example, in ways similar to step 608, FIG. 6).

At step 805 appropriate records are updated. For example, the update may be performed in ways similar to those discussed in connection with step 809 (FIG. 6). Though the medication records may be updated in any suitable way.

In some embodiments, MDU 100 may receive a request from a patient for advanced access to pills to accommodate a circumstance, for example, where the patient anticipates being unable to access the MDU 100. For example, MDU 100 may include a module to receive through its user interface a start time and end time for the period for which medication is requested. MDU 100 may intelligently group pills and provide instructions to the patient.

Having thus described several aspects of at least one embodiment of this invention, it is to be appreciated that various alterations, modifications, and improvements will readily occur to those skilled in the art.

Such alterations, modifications, and improvements are intended to be part of this disclosure and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed to describe an embodiment that is not modified by a term of degree and an embodiment modified by a term of degree.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system comprising:
a plurality of cartridges, each cartridge having a drawer with a plurality of partitions and a linear gear for drawing the drawer from said cartridge;
a cartridge rack having a plurality of slots for holding the plurality of cartridges;
a collection head having a collection receptacle and a pinion for engaging the linear gears;
a gantry system, operably connected to the collection head, to move the collection head within a range of motion of at least two dimensions; and
a motor operably connected to drive the pinion.

2. The system of claim 1, further comprising:
a processor; and
a non-transitory computer-readable storage medium having stored thereon at least one software module having code executable by the processor, the at least one software module including a gantry control module to position the collection head with the pinion engaged to the linear gear of a selected drawer among the plurality of cartridges, wherein, if the pinion is engaged with the linear gear of the selected drawer, the collection receptacle is directly below where the selected drawer opens.

3. The system of claim 2, wherein the at least one software module further includes a motor control module to control the motor to drive the pinion engaged to the linear gear and draw the selected drawer to a selected partition among the plurality of partitions.

4. The system of claim 2, further comprising a plurality of cartridge locks for securing the plurality of cartridges within the cartridge rack, wherein, the at least one software module further includes a cartridge lock control module to control the plurality of cartridge locks.

5. The system of claim 1, further comprising:
a housing with a patient access port,
wherein
the plurality of cartridges, the cartridge rack, the collection head, the gantry system and the motor are enclosed within the housing; and
the gantry system has a first position in the range of motion to at least in part position the collection receptacle at the patient access port.

6. The system of claim 5 wherein the collection receptacle is on a linear track on the collection head and the linear track has (i) a second position wherein the collection receptacle, in combination with positioning the collection head at the first position via the gantry system, is at the patient access port, and (ii) a third position for placing the collection receptacle for collecting contents from the plurality of cartridges.

7. The system of claim 1, wherein
the pinion is a first pinion;
the linear gear is a first linear gear;
each cartridge further comprises a second linear gear for drawing said cartridge from the cartridge rack;
the collection head further comprises a second pinion for engaging the second linear gears; and
the first pinion is setback from the second pinion on the collection head in a direction the plurality of cartridges are drawn from the cartridge rack.

8. The system of claim 7, wherein
the collection head has a first support structure and a second support structure;
the first pinion is mechanically held at a distal end of the first support structure;
the second pinion is mechanically held at a distal end of the second support structure; and
the first and second support structures are rigidly connected to one another.

9. A method comprising acts of:
(i) providing a plurality of cartridges, each cartridge having a drawer with a plurality of partitions and a linear gear for drawing the drawer from said cartridge;
(ii) storing a plurality of objects in the plurality of partitions of the drawers of the plurality of cartridges;
(iii) storing the plurality of cartridges in a plurality of slots of a cartridge rack;
(iv) providing a collection head having a collection receptacle and a pinion for engaging the linear gears;
(v) providing a gantry system operably connected to the collection head, the gantry system for moving the collection head within a range of motion of at least two dimensions;
(vi) controlling the gantry system to at least in part position the pinion of the collection head in the linear gear of the drawer of a selected cartridge among the plurality of cartridges;
(vii) turning the pinion to draw the drawer from the selected cartridge to a selected partition, the selected partition storing at least one selected object among the plurality of objects;
(viii) receiving the at least one selected object in the collection receptacle; and
(ix) controlling the gantry system and the collection head to position the collection receptacle at an access port.

10. The method of claim 9, wherein
the pinion is a first pinion;
the linear gear is a first linear gear;
each cartridge further comprises a second linear gear for drawing said cartridge from the cartridge rack;
the collection head further comprises a second pinion for engaging the second linear gears; and
act (vi) comprises (a) controlling the gantry system to position the second pinion of the collection head in the second linear gear of the selected cartridge, and (b) turning the second pinion, to draw the selected cartridge from its slot of the cartridge rack, at least until the first pinion is positioned in the first linear gear.

11. The method of claim 10, further comprising unlocking a cartridge lock securing the selected cartridge within the slot of the cartridge rack.

12. The method of claim 10, wherein act (vii), turning the first pinion, causes the second pinion to disengage the second linear gear.

13. The method of claim 12, wherein act (vii) the pinion is turned in a first direction, the method further comprising:
after act (viii), turning the first pinion in an second direction opposite the first direction, at least until the drawer is retuned into the selected cartridge and the second pinion is again positioned in the second linear gear.

14. A method comprising acts of:
(i) providing a plurality of cartridges, each cartridge having a drawer with a plurality of partitions;
(ii) storing an object in a select partition among the plurality of partitions in the drawer of a selected cartridge among the plurality of cartridges;
(iii) storing the plurality of cartridges in a plurality of slots of a cartridge rack;
(iv) first controlling a gantry system to position a collection head at the drawer of the selected cartridge;
(v) drawing the drawer from the selected cartridge to the selected partition;
(vi) receiving the object in a collection receptacle of the collection head;
(vii) retuning the drawer into the selected cartridge; and
(viii) second controlling the gantry system and the collection head to position the collection receptacle at an access port.

15. The method of claim 14, wherein the object is a pill.

16. The method of claim 14, wherein
the drawer of each cartridge has a linear gear for drawing said drawer from said cartridge;
the collection head has a pinion for engaging the linear gear;
the act of first controlling comprises positioning the pinion in the linear gear of the drawer of the selected cartridge; and
the act of drawing the drawer comprises turning the pinion in the linear gear.

17. The method of claim 14, wherein
each cartridge has a first linear gear for drawing said cartridge from its respective slot of the cartridge rack;
the drawer of each cartridge has a second linear gear for drawing said drawer from said cartridge;
the collection head has a first pinion for engaging the first linear gear and a second pinion for engaging the second linear gear;
the act of first controlling comprises positioning the first pinion in the first linear gear of the selected cartridge;
the act of drawing comprises
turning the first pinion in the first linear gear in a first direction to draw the selected cartridge from its respective slot in the cartridge rack until the second pinion engages the second linear gear; and
turning the second pinion in the second linear gear in the first direction to draw the drawer of the selected cartridge to the selected partition; and
the act of returning comprises turning the second pinion in the second linear gear in a second direction to return the drawer into the selected cartridge, wherein the second direction is opposite the first direction; and
turning the first pinion in the first linear gear in the second direction to return the selected cartridge into its respective slot in the cartridge rack.

18. The method of claim 14, wherein
the act of drawing further comprises drawing the selected cartridge from its respective slot in the cartridge rack to an unloading position, the unloading position having an edge of the selected cartridge directly above the collection receptacle; and
the act of returning further comprises returning the selected cartridge into its respective slot in the cartridge rack.
